(19) United States
(12) Patent Application Publication
(10) Pub. No.: US 2019/0291544 A1
(43) Pub. Date: Sep. 26, 2019

(54) CARRIER MODULE AND METHOD FOR SIDE LOADING CARRIER MODULE TO A VEHICLE DOOR

(71) Applicant: MAGNA CLOSURES INC., Newmarket (CA)

(72) Inventor: Raymond Edward FORTIN, Newmarket (CA)

(21) Appl. No.: 16/360,230

(22) Filed: Mar. 21, 2019

Related U.S. Application Data
(60) Provisional application No. 62/647,994, filed on Mar. 26, 2018.

(51) Int. Cl. B60J 5/04

(52) U.S. Cl. CPC B60J 5/0416; B60J 5/0468; B60J 5/0418

(57) ABSTRACT

A carrier module for a motor vehicle having inner and outer door panels defining a door panel structure with an internal door cavity is provided. The carrier module includes a pair of carrier members operably coupled to one another. The carrier members are configured for substantially free movement relative to one another to facilitate installation of the carrier members separately from one another into the internal door cavity through an opening formed in the inner panel and have fasteners preassembled thereto to facilitate attaching the carrier members to the inner panel.

### CROSS-REFERENCE TO RELATED APPLICATION

This application claims the benefit of U.S. Provisional Application Ser. No. 62/647,994, filed Mar. 26, 2018, which is incorporated herein by reference in its entirety.

### FIELD

The present disclosure relates generally to vehicle door assemblies, and more particularly to a carrier module of a door assembly having a pair of carrier members configured for attachment to a wet side of a door panel.

### BACKGROUND

This section provides background information related to the present disclosure which is not necessarily prior art.

In many motor vehicle door assemblies, an outer sheet metal door panel and an inner sheet metal door panel are connected together to define an internal door cavity therebetween. An equipment module or sub-assembly, commonly referred to as a carrier module, or simply carrier, is often mounted to a wet side of the inner door panel within the internal door cavity. The carrier is commonly fixed to a barrier that functions as a water and sound barrier (water/sound barrier) and supports various door hardware components. The carrier is typically provided as a single, fixed component including window regulator rails permanently fixed along opposite sides thereof, such that the window regulator rails are fixed relative to one another to facilitate guiding a window upwardly to a closed position and downwardly to an open position. Being a single, fixed component, the outer periphery of the carrier, including a distance extending between upper and lower surfaces of the carrier and a distance extending between outer surfaces of the fixed window regulator rails, defines a fixed outer peripheral envelope that must be able to be assembled into the internal door cavity between the outer and inner door panels without interfering with any other components, and thus, options for ways in which to assemble the carrier within the internal door cavity are typically limited, and in many cases can prove challenging. Further lending to assembly issues of the carrier within the internal door cavity is the presence of a side impact beam, which typically extends across an opening formed in the inner door panel, making assembly of the carrier through the opening of the inner door panel even more challenging. As such, in some cases, the carrier is required to be assembled to the inner door panel prior to assembling the inner door panel to the outer door panel, which can further complicate assembly and add cost thereto. In addition to the above challenges, further challenges include aligning fastener openings in the carrier, which is positioned on the wet side of the inner door panel, with fasteners being passed through openings in the inner door panel during assembly, which can be particularly problematic if being performed in a “blind” assembly process wherein the assembler cannot see the fastener openings in the carrier. Further yet, if the carrier is not properly assembled within the cavity, the integrity of the water/sound barrier can be compromised.

In view of the above, there is a need to provide carrier module that can be readily attached to a wet side of an inner door panel of a door assembly in an economical, reliable and assembler friendly manner so as to avoid compromising the ability of the door assembly to provide enhanced side impact resistance and to provide a reliable watertight seal between wet and dry sides of the door assembly.

### SUMMARY

This section provides a general summary of the disclosure and is not intended to be considered a complete and comprehensive listing of the disclosure's full scope or all of its aspects, advantages, objectives and/or features.

It is an object of the disclosure to provide a carrier module that can be readily attached to an inner door panel of a door assembly in an economical, reliable and assembler friendly manner.

It is a further object of the disclosure to provide a carrier module that avoids compromising the ability of the door assembly to provide enhanced side impact resistance and to provide a reliable watertight seal between wet and dry sides of the door assembly.

In accordance with one aspect, the present disclosure is directed to a door assembly for a motor vehicle configured to include an outer panel, an inner panel, and a carrier module. The outer panel and the inner panel, when connected together, form a door panel structure that is configured to define an internal door cavity. The carrier module is configured to include a pair of carrier members operably coupled to one another via at least one cable. The carrier members are configured for substantially free movement relative to one another to facilitate installation of the carrier members into the internal door cavity through an opening formed in the inner panel and include fasteners preassembled thereto to facilitate fixing the carrier members to the inner panel.

In accordance with another aspect, the present disclosure is directed to providing a carrier module for a motor vehicle having an inner panel and an outer panel defining a door panel structure with an internal door cavity defined between the inner and outer door panels. The carrier module includes a pair of carrier members operably coupled to one another via at least one cable. The carrier members are configured for substantially free movement relative to one another to facilitate installation of the carrier members into the internal door cavity through an opening formed in the inner door panel and include fasteners preassembled thereto to facilitate fixing the carrier members to the inner door panel.

In accordance with another aspect, the present disclosure is directed to providing a carrier module for a motor vehicle having a door panel structure with an inner panel, having an opening bounded by a periphery and at least one support feature, separating a dry side from a wet side of the door panel structure. The carrier module has at least one carrier member with at least one alignment member extending outwardly therefrom. The at least one alignment member is configured for engagement with the at least one support feature for maintaining the at least one carrier member in a partially assembled, unsecured position to the inner panel.

In accordance with another aspect, the at least one carrier member can be provided having at least one fastener opening with a separate fastener secured in each the at least one fastener opening. The separate fastener(s) is configured to extend outwardly from each fastener opening(s) for receipt through the at least one support feature when the at least one carrier member is in the partially assembled position.

In accordance with another aspect, the separate fastener can be provided having a shank extending outwardly from the at least one fastener opening to an enlarged head, with the shank being configured for receipt through the at least one support feature to provide the at least one alignment member, with the enlarged head being configured for receipt of the dry side of the door panel structure.

In accordance with another aspect, the at least one support feature can be provided as at least one of a bounded slot formed through the inner panel and an open slot extending into the periphery of the opening, with the shank being configured for receipt through at least one of the bounded slot and the open slot.

In accordance with another aspect, the at least one support feature can include at least one circumferentially bounded slot formed through the inner panel and at least one open slot extending into the periphery of the opening, wherein the at least one carrier member has a plurality of the fastener openings with a separate fastener secured in each fastener opening, with at least one of the shanks being configured for receipt through at least one of the bounded slot(s) and at least one of the shanks being configured for receipt through at least one open slot(s).

In accordance with another aspect, the present disclosure is directed to a carrier module for a motor vehicle having a door panel structure with an inner panel and outer panel defining an internal door cavity there between, the inner panel having an opening bounded by a periphery sized for receipt of the carrier module there through and including at least one of a plurality of slots extending into the periphery and a plurality of keyhole shaped openings having an enlarged diameter portion and a reduced width slot portion extending from the enlarged diameter portion. The carrier module includes a pair of carrier members operably coupled to one another via at least one cable. The carrier members have fastener openings, and a plurality of fasteners having shanks threaded into the fastener openings. The shanks extend outwardly from the carrier members to enlarged heads spaced from the carrier members, with the shanks being configured for sliding receipt within at least one of the plurality of slots extending into the periphery and the reduced width slot portion of the plurality of keyhole shaped openings.

In accordance with another aspect of the disclosure, the carrier module can further include a barrier member operably coupled to at least one of the carrier members via the fasteners preassembled thereto.

In accordance with another aspect of the disclosure, the barrier member can be spaced from a carrier member(s) preassembled thereto by a gap sized to maintain the barrier member in spaced relation from the inner door panel during assembly of the carrier members to the inner door panel to prevent the barrier member from getting hung-up or otherwise improperly positioned during assembly and to facilitate assembly of the fasteners to the inner door panel during assembly and to further facilitate removal of a protective film from the a seal bead on the barrier member, if provided.

In accordance with another aspect of the disclosure, the inner door panel can further include slots extending laterally into a periphery of the opening therein, wherein the preassembled fasteners can be positioned for sliding receipt of shanks thereof into the slots for subsequent tightening of the fasteners to fix the carrier members in their properly oriented locations on the carrier members and properly aligned locations relative to one another.

In accordance with another aspect of the disclosure, the barrier member can be preassembled to one or more or the fasteners of at least one of the carrier members such that upon tightening the fasteners, at least a portion of the barrier assembly is automatically brought into sealed abutment with the inner door panel.

In accordance with another aspect of the disclosure, the barrier member can be preassembled to one or more or the fasteners of at least one of the carrier members such that the fasteners of the carrier members are readily exposed and accessible after assembly of the carrier members to the inner door panel for subsequent tightening of the fasteners without visual or physical obstruction by the barrier member.

In accordance with another aspect of the disclosure, at least one of the carrier members can be configured in detached relation from the barrier member for free relative movement therewith, such that the at least one detached carrier member can be freely manipulated and inserted through the opening in the inner door panel independently from the other of the carrier members, thereby simplifying assembly and reducing the cost associated therewith.

In accordance with another aspect of the disclosure, one of the carrier members can be fixed to the barrier member via one or more of the fasteners with the other of the carrier members being detached from the barrier member to facilitate assembly.

In accordance with another aspect of the disclosure, the barrier member, fixed to at least one of the carrier members, can be provided having a hinge to facilitate folding, transporting and assembling the carrier module, wherein the hinge can be provided as any suitable hinge, whether via separate hinge members or as an integral living hinge.

In accordance with another aspect of the disclosure, the barrier member can include a continuous peripheral seal bead configured for fixation of the barrier member to the inner door panel.

In accordance with another aspect of the disclosure, the seal bead of the barrier member can be an adhesive material, such as butyl.

In accordance with another aspect of the disclosure, the barrier member can be formed of a fluid impervious, sound barrier grade material, such as from a suitable foam, plastic, nonwoven, textile, or the like.

In accordance with another aspect of the disclosure, the barrier member, fixed to one of the carrier members via fasteners preassembled thereto, can be formed with locating features configured for mating engagement with corresponding locating features of the other of the carrier members to facilitate assembly.

In accordance with another aspect of the disclosure, the opening in the inner door panel can be made relatively small compared to the outer peripheral envelop of the carrier module as fully assembled due to the ability of being able to manipulate at least one of the carrier members independently from the other carrier member during assembly, thus, allowing an increased amount of material to be used to form the inner door panel without impacting the ease of assembly, and thereby enhancing the side impact resistance of the inner door panel and door assembly.

In accordance with another aspect of the disclosure, the sole source of attachment of the carrier members to one another, prior to assembly to the door panel structure, is a flexible member, such as a cable and/or conduit and/or electrical wires, thereby allowing substantially unrestricted relative movement of the carrier members relative to one another during assembly.

In accordance with another aspect of the disclosure, a method of assembling a carrier module into an internal door cavity extending between inner and outer door panels of a motor vehicle door is provided. The method includes providing a carrier module having a pair of carrier members operably coupled to one another and including fasteners preassembled (also referred to as preassembled fasteners) thereto in an assembly state. Further, inserting the carrier members through an opening in the inner door panel into the internal door cavity and disposing the fasteners into openings in the inner door panel, then fixing the carrier members within the internal door cavity by tightening the preassembled fasteners to move the fasteners from the assembly state to an assembled state.

In accordance with another aspect of the disclosure, the method can further include providing the carrier members being coupled to one another via at least one cable, with the carrier members being configured for substantially free movement relative to one another independently from one another, and inserting the carrier members through the opening in the inner door panel separately from one another.

In accordance with another aspect of the disclosure, the method can further include providing the carrier module having a barrier member preassembled to at least one of the carrier members by the preassembled fasteners thereof and closing off the opening of the inner door panel with the barrier member upon tightening the preassembled fasteners.

In accordance with another aspect of the disclosure, the method can further include providing the carrier module having the barrier member preassembled to one of the carrier members by the preassembled fasteners thereof and positioning the barrier member relative to the other of the carrier members by aligning and coupling locating features on the other carrier member with locating features on the barrier member.

In accordance with another aspect of the disclosure, the method can further include bonding the barrier member to a dry side surface of the inner door panel facing an interior of the vehicle upon tightening the preassembled fasteners.

In accordance with another aspect of the disclosure, the method can further include inserting the carrier members into the internal door cavity while the barrier member is folded to facilitate insertion of the carrier members, and then unfolding the barrier member to complete fixation of the barrier member to the outer surface of the inner door panel before or after tightening the preassembled fasteners and fixing the carrier members in the internal door cavity.

In accordance with another aspect of the disclosure, the method can further include maintaining the barrier member in spaced relation from the dry side of the inner door panel via the preassembled fasteners fixed to the barrier member and then bringing the barrier member into abutment with the dry side of the inner door panel after inserting the carrier members into the cavity and upon tightening the preassembled fasteners.

In accordance with another aspect of the disclosure, the method can further include sliding at least some of the preassembled fasteners into slots extending laterally into a periphery bounding the opening of the inner door panel.

In accordance with another aspect of the disclosure, the method can further include inserting at least some of the preassembled fasteners into a keyhole-shaped opening in the inner door panel prior to sliding other of the preassembled fastener(s) into slots extending laterally into a periphery bounding the opening of the inner door panel.

In accordance with another aspect of the disclosure, there is provided a door assembly for a vehicle, including an outer panel, an inner panel attached to the outer panel and having an opening bounded by a periphery with at least one of a plurality of slots extending into the periphery and a plurality of keyhole shaped openings having an enlarged diameter portion and a reduced width slot portion extending from the enlarged diameter portion. The door assembly includes a pair of carrier members operably coupled to one another via at least one cable, with the carrier members having fastener openings and a plurality of fasteners having shanks threaded into the fastener openings. The shanks extend outwardly from the carrier members to enlarged heads spaced from the carrier members, with the shanks being received slidingly within at least one of the plurality of slots extending into the periphery and the reduced width slot portion of the plurality of keyhole shaped openings.

In accordance with another aspect of the disclosure, the shanks are received slidingly within the slots of the inner panel and the enlarged heads overlie a substantially planar surface of the inner panel adjacent the slots.

In accordance with another aspect of the disclosure, the shanks are received slidingly within the reduced width slot portion of the plurality of keyhole shaped openings and the enlarged heads overlie a substantially planar surface of the inner panel adjacent the reduced width slot portion.

In accordance with another aspect of the disclosure, a barrier member is attached to at least one of the carrier members by at least one of the plurality of fasteners.

In accordance with another aspect of the disclosure, the barrier member is detached from the fasteners of the other of the carrier members.

In accordance with another aspect of the disclosure, the barrier member is sandwiched between the enlarged head of the at least one fastener and the at least one carrier member, and further including a washer disposed in an interference fit on the at least one fastener between the barrier member and the at least one carrier member.

In accordance with another aspect of the disclosure, the disclosure is directed to a carrier module for a motor vehicle having a door panel structure with an inner panel, the inner panel having an opening bounded by a periphery and at least one support feature. The carrier module includes at least one carrier member and at least one alignment member extending outwardly from the at least one carrier member. The at least one alignment member is configured for engagement within the at least one support feature for maintaining the at least one carrier member in a preassembled position unsecured to the inner panel.

In accordance with another aspect of the disclosure, the at least one carrier member includes at least one fastener opening for securing a fastener. The inner panel further including a port for receipt of part of the fastener there through, wherein when the at least one carrier member is in the preassembled position the port and the at least one fastener opening are aligned.

In accordance with another aspect of the disclosure, the at least one fastener each include a shank, wherein the fastener, partially secured in the fastener opening, provides the at least one alignment member extending outwardly from the at least one carrier member, and the port provides the at least one support feature.

In accordance with another aspect of the disclosure, the at least one support feature is at least one of a slot extending into the periphery of the inner panel and an opening extending through the inner panel.

In accordance with another aspect, there is provided a method of assembling a carrier module to an inner panel of a motor vehicle door, including providing a carrier module including fasteners having shanks and enlarged heads, with the shanks being threaded into fastener openings thereof, sliding the shanks of the fasteners within at least one of a plurality of slots extending into a periphery bounding an opening in the inner panel and a reduced width slot portion of a plurality of openings extending through the inner panel, and tightening the fasteners and bringing the enlarged heads into compression relative to the inner panel.

In accordance with another aspect, there is provided a method of assembling a carrier module to an inner panel of a motor vehicle door, including providing a carrier module including fasteners having shanks and enlarged heads, with the shanks being threaded into fastener openings thereof, and alignment member extending from the carrier module, sliding alignment members within at least one of a plurality of slots extending into a periphery bounding an opening in the inner panel and a plurality of openings extending through the inner panel, and tightening the fasteners and bringing the enlarged heads into compression relative to the inner panel.

Further areas of applicability will become apparent from the description provided herein. The description and specific examples in this summary are only intended to illustrate certain non-limiting embodiments which are not intended to limit the scope of the present disclosure.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1 illustrates a motor vehicle with a door assembly;

FIG. 2 illustrates a carrier module of the door assembly of FIG. 1 constructed in accordance with one aspect of the disclosure;

FIG. 2A is an enlarged view of a B-pillar carrier member of the carrier module of FIG. 2;

FIG. 2B is an enlarged view of an A-pillar carrier member of the carrier module of FIG. 2;

FIG. 3 illustrates the carrier module of FIG. 2 in an initial stage of assembly to the door assembly of FIG. 1;

FIG. 4 illustrates the carrier module of FIG. 2 shown partially assembled to the door assembly of FIG. 1;

FIG. 5 illustrates the carrier module of FIG. 2 shown fully assembled to the door assembly of FIG. 1;

FIG. 6 illustrates a partial plan view of an inner door panel of the door assembly of FIG. 1;

FIG. 6A is enlarged view of an encircled portion 6A of FIG. 6;

FIG. 6B is enlarged view of an encircled portion 6B of FIG. 6;

FIG. 6C is enlarged view of an encircled portion 6C of FIG. 6;

FIG. 7 illustrates an enlarged cross-sectional view of the encircled area 7 of FIG. 5 showing a barrier member of the carrier module assembled to the B-pillar carrier member;

FIG. 8 is a view similar to FIG. 7 of the encircled area 8 of FIG. 5 shown in a partially assembled state;

FIG. 8A is an enlarged cross-sectional view taken generally along the line 8A-8A of FIG. 8;

FIG. 8B is a view illustrating the portion of FIG. 8A illustrating the barrier member in phantom and in a fully assembled state;

FIG. 8C is an enlarged cross-sectional view taken generally along the line 8C-8C of FIG. 8 illustrating the barrier member in a fully assembled state; and

FIG. 9 is a flowchart illustrating a method of assembling a carrier module into an inner panel of a motor vehicle door panel structure.

### DETAILED DESCRIPTION OF EXAMPLE EMBODIMENTS

In general, example embodiments of a door assembly and carrier module therefor constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

The carrier module embodiment disclosed in accordance with one aspect of the disclosure includes a barrier member and a pair of carrier members configured to provide a pre-installed/collapsed arrangement and a post-installed/assembled arrangement, with a pair of window regulators integrally attached to the carrier members, wherein the carrier members are operably coupled to one another via flexible members, such as cables and/or conduits, thereby allowing the carrier members and associated window regulators to be independently moved and positioned relative to one another, with fasteners preassembled to the carrier members to facilitate assembly.

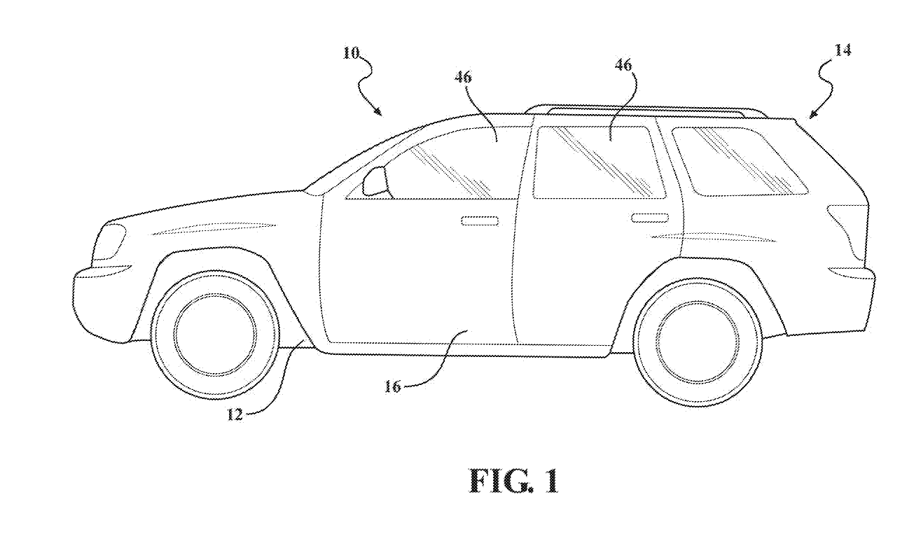

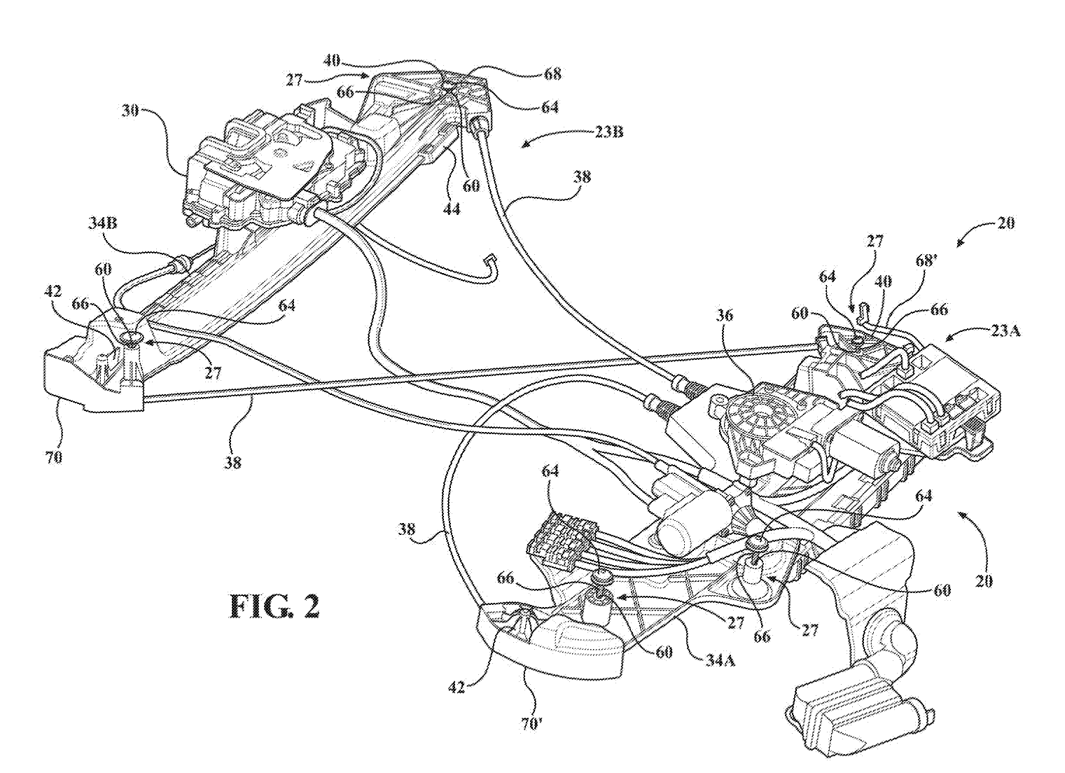

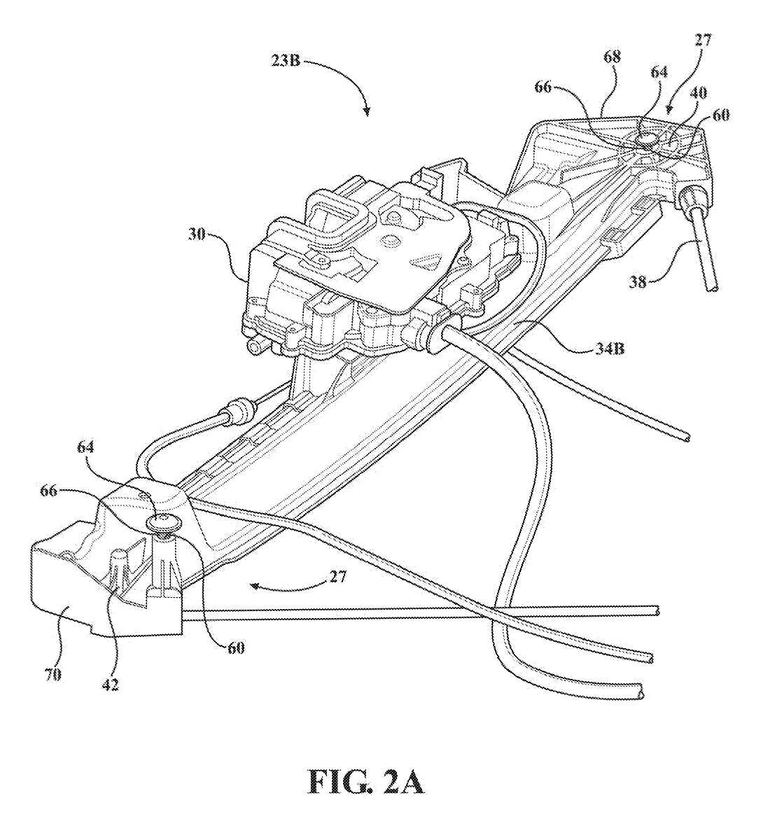

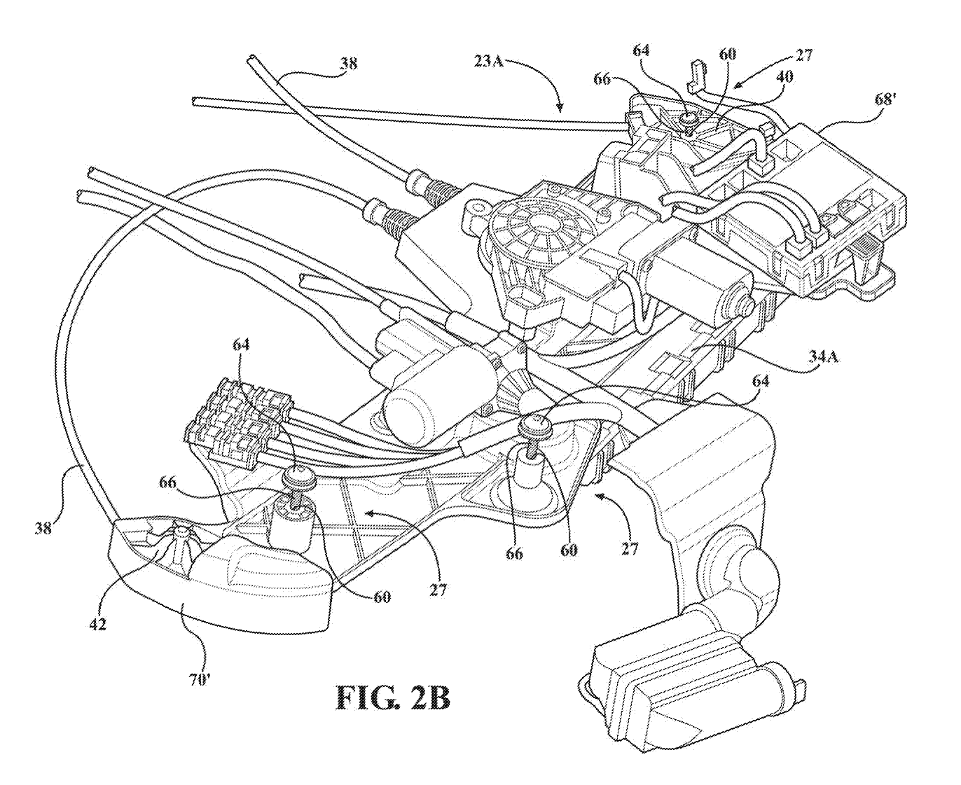

Reference is made to FIG. 1, which shows a door assembly 10 mounted to a body 12 of a motor vehicle 14. The door assembly 10 includes an outer door panel, also referred to as outer panel 16, an inner door panel, also referred to as inner panel 18 (FIGS. 3-5), an intrusion member 19 and a carrier module 20 (FIGS. 2-5), shown constructed in accordance with one presently preferred aspect of the disclosure. The assembly, integrity and structural impact resistance of the door assembly 10 is facilitated and enhanced directly as a result of the configuration and arrangement of the carrier module 20, as discussed further hereafter and as will be readily appreciated by one skilled in the art.

The outer panel 16 forms at least part of the exterior surface of the door assembly 10. The inner panel 18 provides a structural member for the mounting of one or more trim pieces that form an inner surface of the door assembly 10. The outer and inner panels 16, 18 are connected together to provide a door panel structure 17 that forms an internal door cavity 22 (FIGS. 3-5) that contains various components of the door assembly 10, including a pair of carrier members 23A, 23B of the carrier module 20. The inner panel 18 has at least one, and shown as a pair of openings 24A, 24B, by way of example and without limitation. The openings 24A, 24B are shown as being formed on opposite sides of the inner panel 18 with a central support member or rail 26 extending therebetween. The central support rail 26 can be formed as an integral, monolithic piece of material with the inner panel 18, thereby rendering the inner panel 18 economical in manufacture and enhancing the structural integrity, strength and side impact resistance of the inner panel 18. Due to the ability of the carrier members 23A, 23B to be moved relative to one another, the size of the individual openings 24A, 24B needed in the inner panel 18 for assembly of the carrier module 20 can be minimized. As such, the amount and area of material forming the inner panel 18 can be maximized, thereby increasing the side impact strength of the inner panel 18 relative to inner panels having substantially larger central openings. Further yet, due to the incorporation of alignment members, provided as fasteners 27 preassembled to the carrier members 23A, 23B, the assembly of the carrier members 23A, 23B to the inner panel 18 is made reliable, quick and easy and facilitates their proper positioning to enhance the assembly and operation thereof.

The outer and inner panels 16, 18 may be made from any suitable material or combination of materials. For example, the outer and inner panels 16, 18 may both be made from a suitable metal (e.g. a suitable steel). In another example, the outer panel 16 may be made from a suitable polymeric or composite material (e.g. fiberglass) and the inner panel may be made from a suitable metal, by way of example and without limitation.

A pair of hinges 28 are connected to door panel structure 17 and pivotally mount a front end of door panel structure 17 (and door assembly 10) to the vehicle body 12. A door latch 30 is mounted to the rear end of door panel structure 17 to permit the releasable closure of door assembly 10 against vehicle body 12.

The carrier module 20 is shown including a barrier member, shown as being a collapsible barrier member 32, by way of example and without limitation integrally attached to the carrier member 23A via the pre-assembled fasteners 27 thereof, as discussed further below, with each carrier member 23A, 23B having and a window regulator rail 34A, 34B, respectively, and a plurality of door hardware components operably mounted thereto. In this non-limiting example, at least some of the door hardware includes a power-operated window regulator 36 having an electric motor-driven cable 38, a pair of upper pulleys 40 and lower pulleys 42 (FIG. 2), a pair of lifter plates 44 for moving a window 46 within a pair of glass run channels 48. Other hardware components shown are well understood by those skilled in the art, and thus, need no explanation, in addition to other components that can be provided, but are now shown.

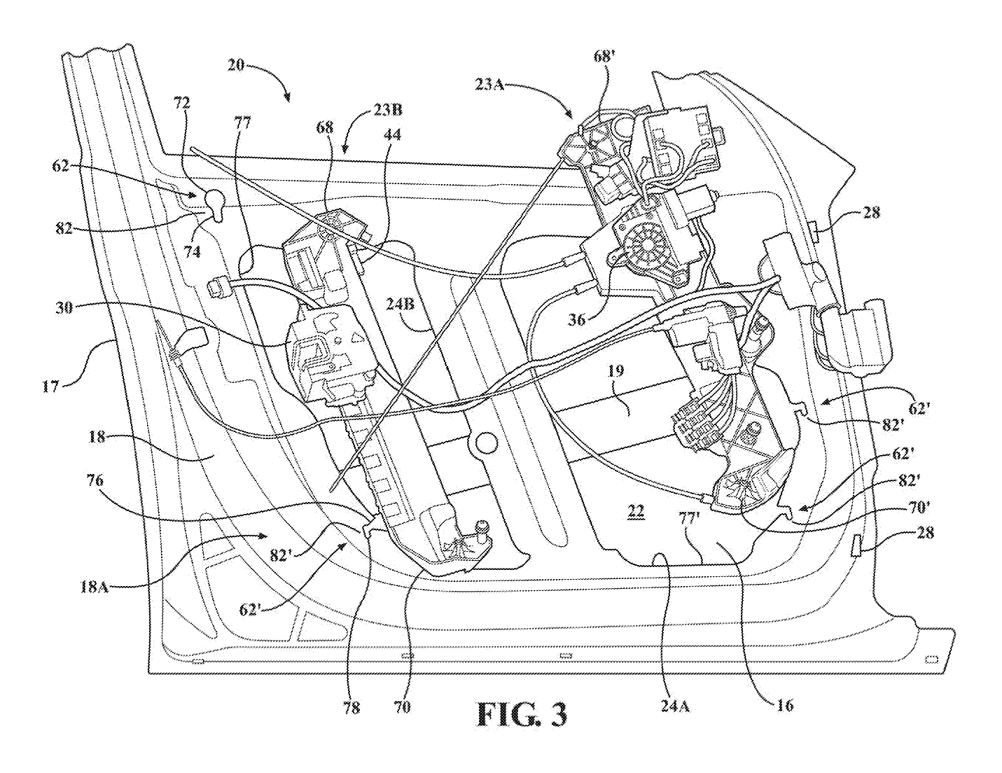

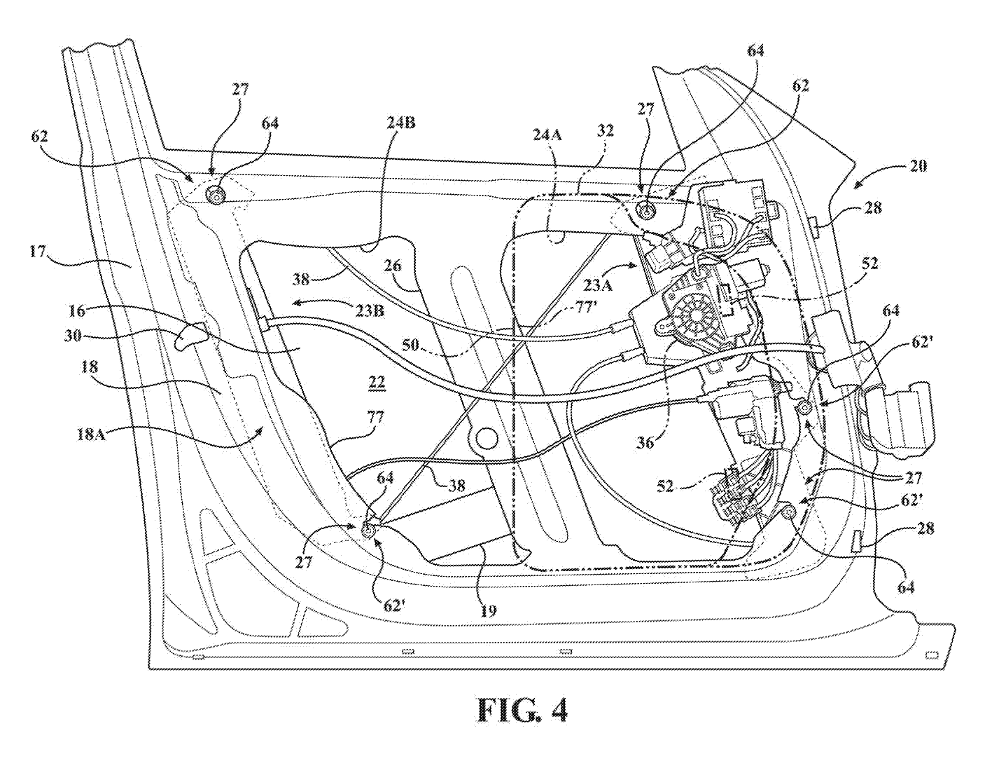

In accordance with a non-limiting embodiment, barrier member 32, intended to function both as a fluid (water) barrier, debris barrier and as a sound barrier, can be provided as a single-piece panel assembly. The barrier member 32 is adapted to be automatically fixed in its proper location and sealed against a dry side 18A of the inner panel 18 upon fixing the carrier members 23A, 23B to a wet side 18B of the inner panel 18, as discussed in more detail below. The barrier member 32 is preferably collapsible, and is shown as being foldable in half, or substantially in half as via a hinge 50, such as a living hinge or other mechanical hinge arrangement. Accordingly, it is to be recognized that the barrier member 32 can be formed as a single piece of material (living hinge), or from separated pieces of material hingedly joined to one another. As such, the barrier member 32 can be provided to fold into the desired configuration to enhance the ease of assembly of the carrier members 23A, 23B into the internal door cavity 22, and in addition, to reduce the package size required for shipping and the space needed for storage of carrier module 20. To further facilitate maintaining the barrier member 32 in a folded configuration, the barrier member 32 can be provided with fastener features 52 that releasably couple to one another while the barrier member 32 is in a folded state, thereby facilitating handling, whereupon the fastener features 52 (FIG. 4) can be readily uncoupled from one another during assembly. It is contemplated herein that the fastener features 52 could be provided as a hook-and-loop type fastener, snaps, and the like.

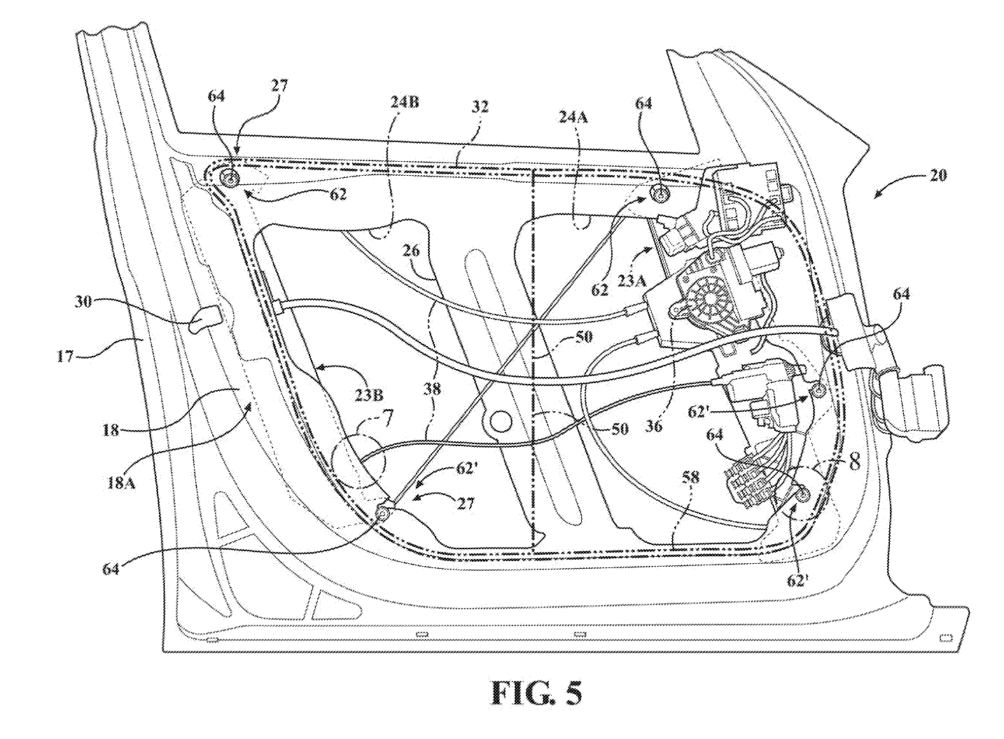

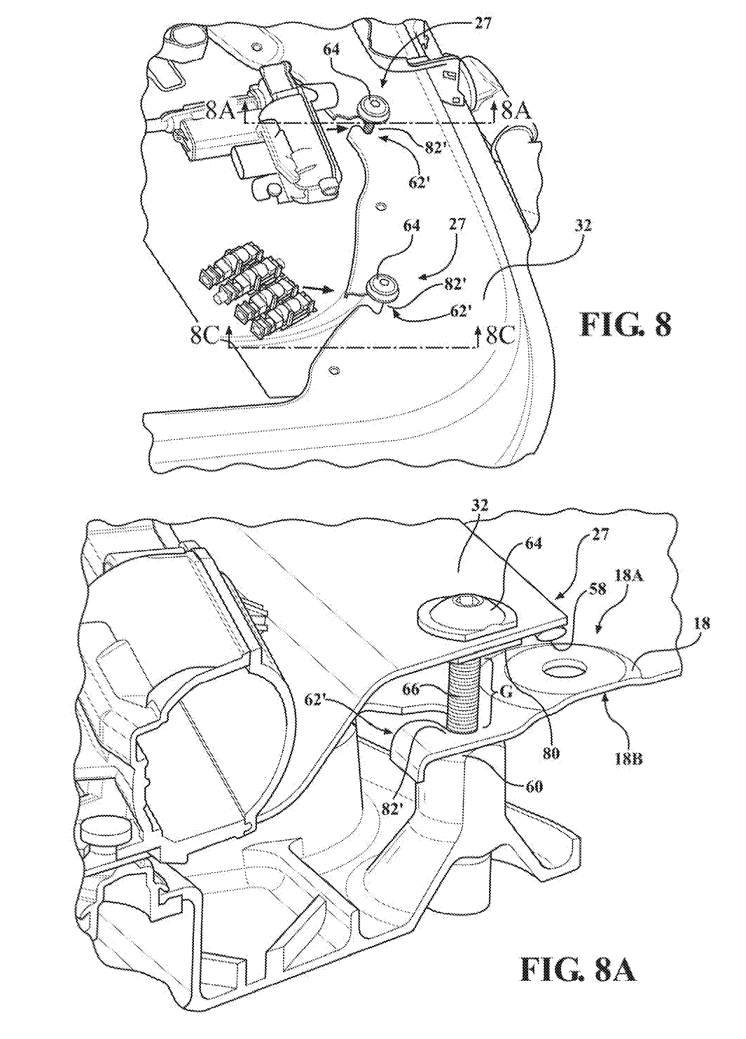

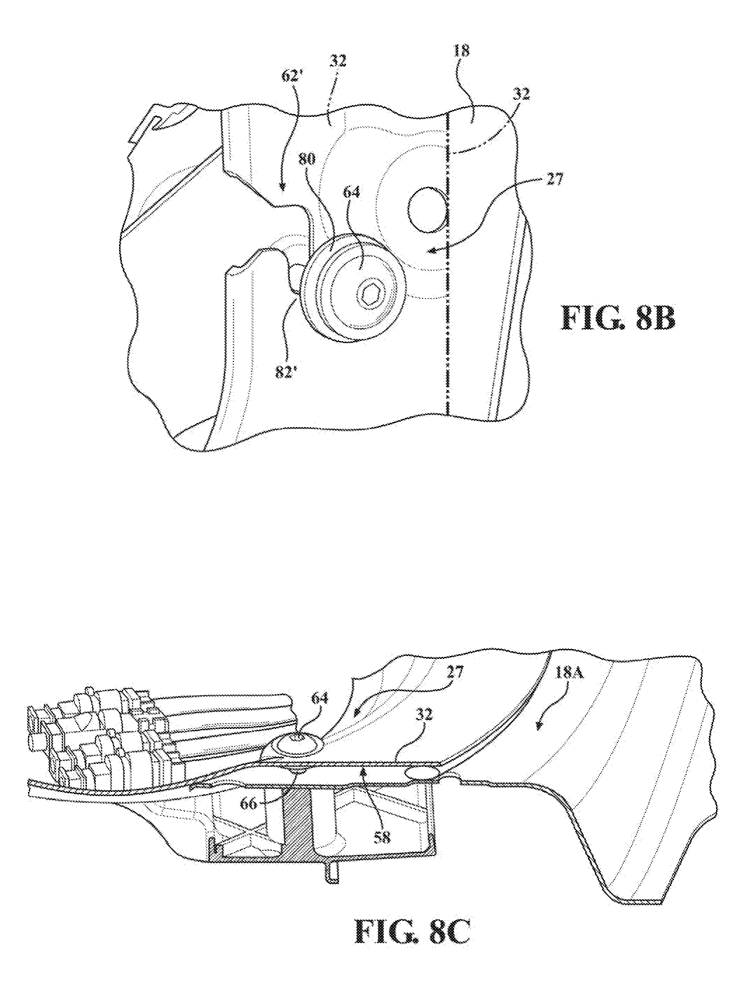

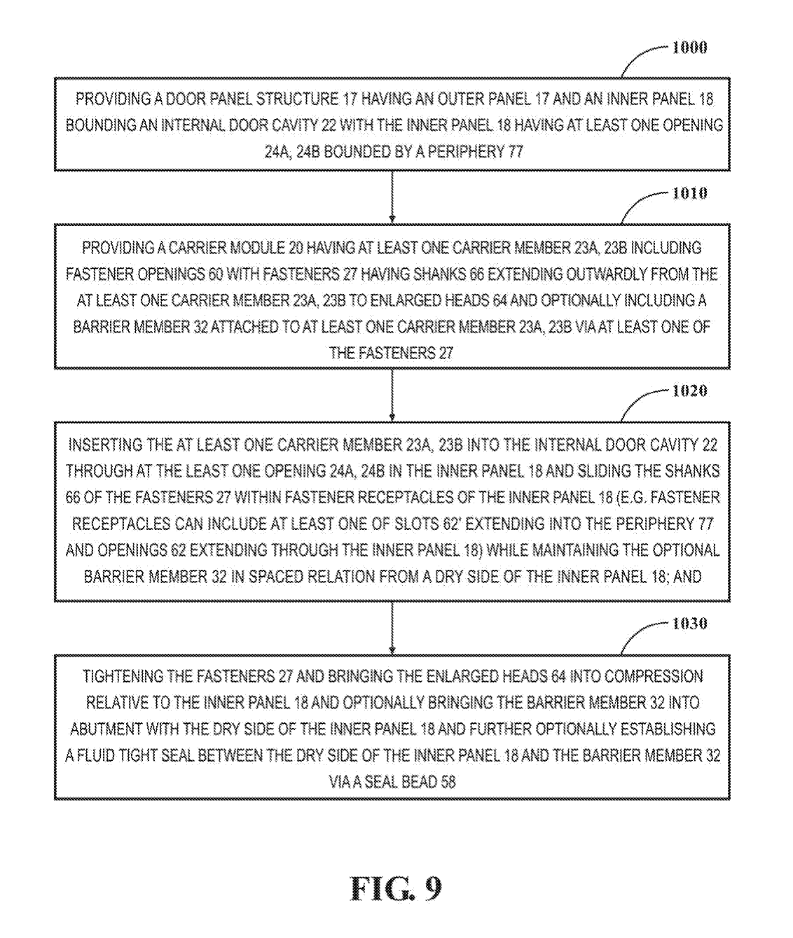

The barrier member 32 can be formed of any suitable fluid and sound (fluid/sound) barrier material, as desired, in order to meet the necessary specifications, such as a foam, plastic, nonwoven, textile, and/or like materials. Further, in order to facilitate assembly, including ensuring the barrier member 32 is properly located against the dry side 18A of the inner panel 18, the barrier member 32 can be formed with locating features 54, shown by way of example as female recesses, configured for mating engagement with corresponding locating features 56, shown by way of example an male protrusions, (FIG. 7) on the carrier member 23B. Further yet, to ensure a fluid-tight seal is established between the barrier member 32 and the dry side 18A of the inner panel, the barrier member can further include a peripherally extending seal bead 58 (FIGS. 5 and 8). The locating features 54, 56 can be formed to provide a snug, interference fit with one another, and thus, no additional fastening mechanism is needed. The seal bead 58 can be provided as any suitable adhesive material capable of maintaining a fluid-tight seal between the barrier member 32 and an outer surface of the dry side 18A of inner panel 18, such as butyl, by way of example and without limitation. A protective film can be provided to cover the seal bead 58 until it is desired to expose the seal bead 58 for assembly, as discussed further below.

With the carrier members 23A, 23B being able to be freely manipulated for movement relative to one another, assembly is made easy and it also greatly reduces the package size required for shipping and the space needed for storage, since the carrier members 23A, 23B can essentially be stacked on or adjacent one another, with the barrier member 32 manipulated into a folded state via hinge 50, to assume a relatively small outer peripheral envelop. The sole source of attachment of the carrier members 23A, 23B to one another is the flexible member 38, e.g., a cable and/or conduit and/or electrical wires, such as those needed for operable functioning of various components of the door assembly 10. Accordingly, substantially unrestricted relative movement is provided between the carrier members 23A, 23B during assembly. As such, as discussed above, the size of the opening(s) 24 in the inner panel 18 can be made relatively small for insertion of the carrier members 23A, 23B into the internal door cavity 22, thereby allowing for an increased area of material to be provided by the inner panel 18 to optimize the moment of inertia of the panel 18 and side impact resistance of the door assembly 10.

To further improve assembly and reduce the cost associated therewith, the fasteners 27 of the carrier members 23A, 23B are provided preassembled to carrier members 23A, 23B. The fasteners 27 are preassembled within openings, such as threaded fastener openings 60, of the carrier members 23A, 23B, wherein the fastener openings 60 are located in predetermined positions such that the fasteners 27 are automatically located for receipt within preformed support features, shown as ports, also referred to as fastener receptacles 62, 62′, in the inner panel 18. The fasteners 27 are initially assembled for partially threaded securement to the carrier members 23A, 23B to a preassembled state, such that the fasteners 27 are not fully threaded into the fastener openings 60 to a fully threaded state. In their preassembled state, an enlarged head 64 of the fasteners 27 is spaced sufficiently from the respective carrier member 23A, 23B by a gap (G) (FIG. 8A) that extends axially along a threaded shank 66 to facilitate assembly of the carrier members 23A, 23B to the inner panel 18, as discussed further below.

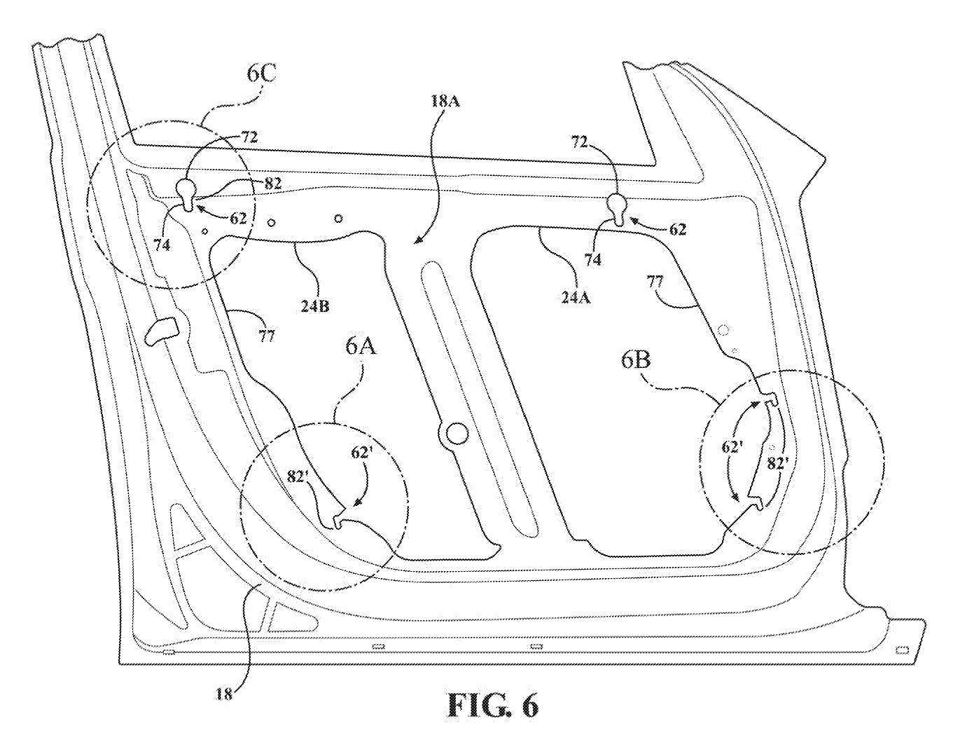

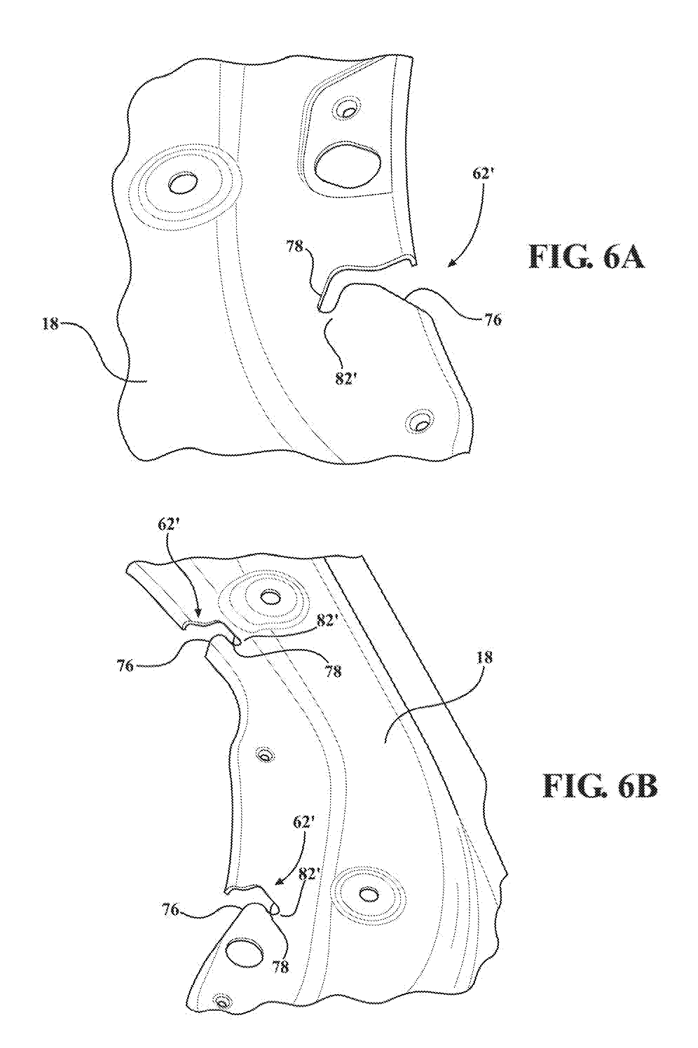

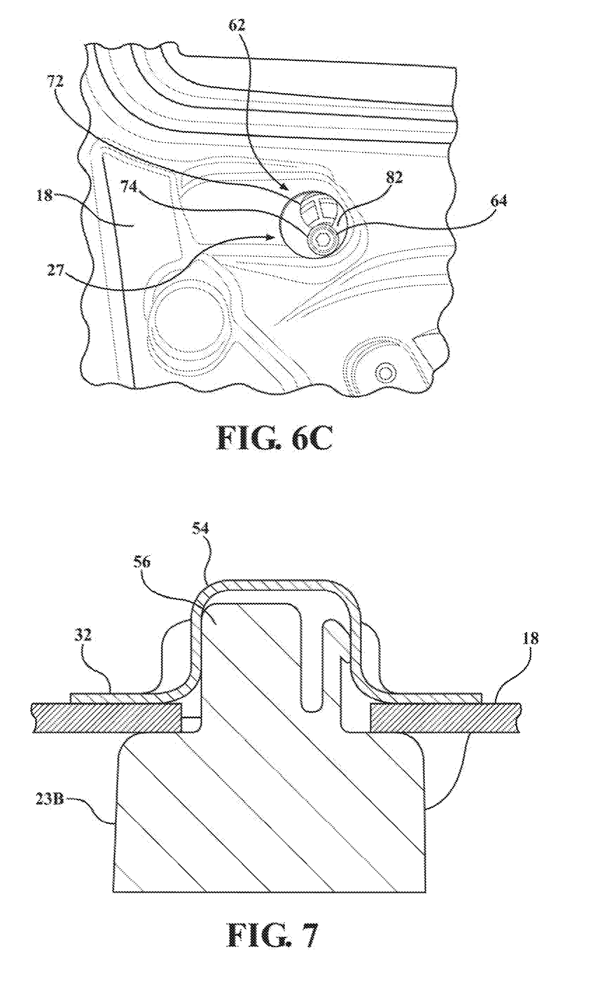

In accordance with one aspect, the carrier member 23B can have a plurality of fasteners 27 preassembled thereto, shown as a pair of fasteners 27, by way of example and without limitation, such that the pair of the fasteners 27 are located adjacent opposite upper and lower ends 68, 70 of the carrier member 23B. During assembly, the carrier member 23B can be inserted through the opening 24B to bring the fastener openings 60 and fasteners 27 preassembled therein into alignment with their respective fastener receptacles 62, 62′ for insertion therein, with the enlarged heads 64 disposed and remaining on the dry side 18A of inner panel 18. The fastener receptacle 62 configured for receipt of the fastener 27 adjacent the upper end 68 of the carrier member 23B can be provided as a bounded slot, shown as a keyhole-shaped through opening 62, being circumferentially bounded for example, and not in open communication with larger opening 24, having an enlarged diameter annular upper portion 72 sized for clearance receipt of the enlarged head 64 of the fastener 27 there through, with a reduced width channel or slot lower portion 74 extending downwardly from the upper portion 72 (FIGS. 3, 6 and 6C). The fastener receptacle 62 configured for receipt of the fastener 27 adjacent the lower end 70 of the carrier member 23B can be provided as an elongate slot 62′ having a length greater than a width thereof, shown as being generally L-shaped, having an elongate, generally horizontal entrance first portion 76 extending into a periphery 77 bounding the opening 24B, and thus, being openly exposed to the opening 24B, and an elongate second portion 78 extending downwardly from the first portion 76 (FIGS. 3 and 6A). The entirety of the slot 62′ can be sized for a slight clearance fit of the threaded shank 66 of the fastener 27, while being sized across its width to prevent the enlarged head 64 from passing there through. As such, the enlarged head 64 of the fastener 27 adjacent the upper end 68 of the carrier member 23B can be inserted through the upper portion 72 of the keyhole-shaped fastener receptacle 62 and the treaded shank 66 of the fastener 27 adjacent the lower end 70 of the carrier member 23B can be slid into the first portion 76 of the L-shaped slot with the enlarged heads 64 remaining on the dry side 18A of inner panel 18. Then, the carrier member 23B can be pushed downwardly so that the threaded shank 66 of the fastener 27 adjacent the upper end 68 of carrier member 23B can be slid into the slot-shaped lower portion 74 of the keyhole shaped receptacle 62, whereupon the enlarged head 64 is prevented from passing through the lower portion 74 by overlying a substantially planar surface 82 of the inner panel 18 immediately adjacent the slot-shaped lower portion 74. Simultaneously, the threaded shank 66 of the faster 27 adjacent the lower end 70 of carrier member 23B can slide downwardly into the second portion 78 of the L-shaped slot. When threaded shank 66 is supported by the slot 62, 62′, the carrier 23 is in a preassembled position for tightening the pair of fasteners 27, for example as shown in FIG. 4. That is, an assembler need not be required to physically maintain alignment of the carrier members 23A, 23B relative to the opening 24 or fastener openings 62 relative to fastening ports, such as slots 62, 62′ or other openings configured to receive there through part of a fastener, such as a shank 66, but prevent passage there through of a fastener head, such as a fastener head 64. As a result, the ease of assembly of the carrier module 20 to the inner panel 18 is improved. Illustratively, the pair of fasteners 27 provide the dual purpose of forming the alignment features, and the components for transitioning the carrier members 23A, 23B from an unsecured position away from the inner panel 18 to a secured position maintained adjacent and in contact, such as sealing contact, with inner panel 18. In an alternative embodiment, the alignment features may be distinct from the fasteners 27, such that the engagement of the alignment member with the support feature, such as slot 62, 62′ or periphery edge 77 provides for a preassembled position of the carrier module 22 relative to the inner panel 18, for example as shown in FIG. 5. For example, alignment member may be an integrally formed hook, snap, or lip or protruding member, provided as part of the carrier members 23A, 23B, and for example hook may be provided at any location of the carrier members 23A, 23B to engage the inner panel 18 and support the carrier members 23A, 23B in a preassembled position relative to the inner panel 18. In an embodiment, the alignment member may provide for the carrier members 23A, 23B to hang in the preassembled position; in another embodiment the alignment member may provide for the carrier members 23A, 23B to be supported from a top or a bottom engagement, or both, between the carrier members 23A, 23B and the inner panel 18; in another embodiment the alignment member may provide for the carrier members 23A, 23B to be supported from a middle portion of the carrier members 23A, 23B such as between the periphery 77 of openings 24A, 24B; in another embodiment, the alignment feature may be provided as snaps for engaging the inner panel 18, such as for engaging the peripheral edges 77 of the openings 24A, 24B. Next, the pair of fasteners 27 can be tightened via any suitable tool configured for engagement with a tool receiving portion of enlarged head 64, shown as a hex-shaped receptacle, by way of example and without limitation, to bring the enlarged head 64 into overlying relation with a substantially planar surface 82′ of the inner panel 18 immediately adjacent the second portion 78 of the slot 62′ and into fixed engagement with the dry side 18A of the inner panel 18, and thereby securing the carrier module 20 to the inner panel 18 in an assembled position. Threaded shank 66 is illustrated herein as an example of an alignment member outwardly extending from the at least one carrier member 23A, 23B, the at least one alignment member being configured for 66 engagement within the at least one support feature, such as the slot 62, 62′, provided on the inner panel 18 for maintaining the at least one carrier member 23A, 23B in a preassembled position that is unsecured (not fully fastened) to the inner panel 18. When fasteners 27 are tightened from a partially threaded, preassembled state to a threaded, fully assembled state within fastener openings 67, the carrier module 20 is brought into a fully assembled position relative to the inner panel 18.

In accordance with a further aspect, the carrier member 23A can have a plurality of fasteners 27 preassembled thereto, shown as three fasteners 27, by way of example and without limitation, such that two of the fasteners 27 are fixed adjacent opposite upper and lower ends 68′, 70′ of the carrier member 23A, with the remaining fastener 27 shown located intermediate the pair of fasteners 27 adjacent the upper and lower ends 68′, 70′. In addition, the barrier member 32 can be preassembled to the carrier member 23A via the fasteners 27. As best shown in FIG. 8A, through holes in the barrier member 32 can be pressed about the threaded shanks 66 to bring the barrier member 32 into abutment with the enlarged heads 64 of the fasteners 27. To retain the barrier member 32 against the enlarged heads 64 to facilitate assembly, washers 80 can be pressed in a slight interference fit about the threaded shanks 66 to hold the barrier member 32 against the enlarged heads 64 to maintain the gap G between the barrier member 32 and the inner panel 18 during assembly. Further, it is contemplated that the through holes in the barrier member 32 could be sized for a slight interference fit about the threaded shanks 66, if desired. As discussed above, the barrier member 32 can be folded in half and releasably fixed in the folded state via the fastener features 52 such that the fasteners 27 remain exposed for ease of assembly.

During assembly, the carrier member 23A can be inserted through the opening 24A to bring the fasteners 27 into alignment with their respective fastener receptacles 62 for insertion therein. The fastener receptacle 62 configured for receipt of the fastener 27 adjacent the upper end 68′ of the carrier member 23A can be provided having a keyhole-shaped through opening having an enlarged diameter upper portion 72 sized for clearance receipt of the enlarged head 64 of the fastener 27 there through, with a reduced width slot lower portion 74 extending downwardly from the upper portion 72. The fastener receptacles 62 configured for receipt of the fastener 27 adjacent the lower end 70′ of the carrier member 23B and the intermediate fastener 27 can be provided as elongate slots, as discussed above, shown as being generally L-shaped, having the generally horizontal entrance first portion 76 extending into a periphery 77′ bounding the opening 24A and a second portion 78 extending downwardly from the first portion 76 (FIG. 3). The entirety of the slots 62′ can be sized for a slight clearance fit of the threaded shanks 66 of the fasteners 27, while being sized to prevent the enlarged heads 64 from passing there through. As such, the enlarged head 64 of the fastener 27 adjacent the upper end 68′ of the carrier member 23A can be inserted through the upper portion 72 of the keyhole-shaped fastener receptacle 62 and the treaded shanks 66 of the other two lowermost and intermediate fasteners 27 can be slid into the respective first portions 76 of the L-shaped slots. While inserting the fasteners 27 into the fastener receptacles 62, the barrier member 32, along with the enlarged heads 64, is maintained in spaced relation away from the dry side 18A of the inner panel 18 as a result of being captured against the enlarged heads 64 via washers 80, and thus, assembly is made easy by providing space to see the fastener receptacles 62 during assembly, and further preventing the barrier member 32 from getting caught or otherwise hung up on the inner panel 18. Then, the carrier member 23A can be pushed downwardly so that the threaded shank 66 of the fastener 27 adjacent the upper end 68′ of carrier member 23A can be slid into the slot or channel-shaped lower portion 74 of the keyhole-shaped receptacle 62, whereupon the enlarged head 64 is prevented from passing through the reduced width (relative to the enlarged upper portion 72) lower portion 74, while the threaded shanks 66 of the lowermost and intermediate fasteners 27 can slide downwardly into the second portions 78 of the L-shaped slots. Next, each of the fasteners 27 can be tightened via any suitable tool, as discussed above, to fix the carrier member 23A in position and simultaneously bring the barrier member 32 and the seal bead 58, if provided, into sealed abutment with the dry side 18A of the inner panel 18. Then, the barrier member 32 can be unfolded to bring the locating features 54 of the barrier member 32 into attachment with the locating features 56 of the carrier member 23B, while also bring the seal bead 58 into sealed relation with the dry side of the inner panel 18.

In accordance with an embodiment, there is provided a carrier module 20 for a motor vehicle 14 having a door panel structure 17 with an inner panel 18, with the inner panel 18 having at least one opening 24A, 24B bounded by a periphery 77 and at least one support feature, such as an opening 62, 62′ or peripheral edge 77 of opening 24A, 24B. The carrier module 20 includes at least one carrier member 23A, 23B and at least one alignment member, such as fastener 27 extending outwardly in a preassembled state from the at least one carrier member 23A, 23B. The at least one alignment member 27 is configured for alignment and engagement within the at least one support feature 62, 62′ for maintaining the at least one carrier member 23A, 23B in a preassembled position unsecured to the inner panel 18, for example as shown in FIG. 4 whereby the carrier member 23A, 23B is positioned adjacent to the inner panel 18 without the carrier member 23A, 23B being fixedly engaged with inner panel 18. The inner panel 18 further includes a port, such as opening 62, 62′ for example, or other dedicated fastener port or hole provided on the inner panel 18 for receipt of part of the fastener 27 there though, such as the shank 66, while preventing an enlarged portion, such as enlarged head 64 for example, of the fastener 27 from passing there though, such that when the at least one carrier member 23A, 23B is in the preassembled position, the port 62, 62′ and a fastener opening 60 provided on the carrier member 23A, 23B are aligned for allowing the shank 66 to be received by the fastener opening 60. The at least one fastener 27 may each comprise a shank 66, wherein the fastener 27 partially secured, for example partially threaded as shown in FIG. 8, in the fastener opening 60 provides the at least one alignment member 66 extending outwardly from the carrier member 23A, 23B, and the port providing the at least one support feature. The at least one support feature is illustratively, for example, at least one of a bounded slot, also referred to as through opening 62, formed on the inner panel 18 and an open slot 62′ extending into the opening 24.

In accordance with a further aspect of the disclosure, a method of assembly a carrier module 20 into an internal door cavity 22 of a vehicle door panel structure 17 is provided starting a step 1000 by providing the door panel structure 17 having an inner panel 18 with at least one opening 24A, 24B bounded by a periphery 77. Further, at step 1010 providing a carrier module 20 having at least one or a pair of carrier members 23A, 23B operably coupled to one another, with the at least one carrier member 23A, 23B including fastener openings 60 with fasteners 27 having shanks 66 and enlarged heads 64, with the shanks 66 being threaded into the fastener openings 60 and extending outwardly from the at least one carrier member 23A, 23B to the enlarged heads 64. Next, at step 1020, inserting the at least one carrier member 23A, 23B into the internal door cavity 22 through at the least one opening 24A, 24B in the inner panel 18 and sliding the shanks 66 of the fasteners 27 within fastener receptacles 62, 62′, wherein the fastener receptacles 62, 62′ can include at least one of a plurality of slots 76, 78 of openings 62′ extending into a periphery 77 bounding the opening 24A, 24B in the inner panel 18 and a reduced width slot portion 74 of a plurality of keyhole shaped openings 62 extending through the inner panel 18. Then, at step 1030 tightening the fasteners 27 and bringing the enlarged heads 64 into compression relative to the dry side 18A of the inner panel 18. Other shapes for opening 62 may be provided, such as for example an elongated slot, a notched circular shape, a triangle for receiving the alignment member to support the carrier 23 in a preassembled position, as well as for providing optionally locking functionality with the carrier module 20 in the preassembled position so that the alignment feature 66 may not easily become disengaged with the opening 62, 62′, for example as may requiring a translation, rotation, or other change in orientation of the alignment member 66 relative to the opening 62, 62′.

In accordance with a further aspect of the disclosure, the method can further include at step 1010 attaching a barrier member 32, configured to close off the opening 24A, 24B in the inner panel 18, to at least one of the carrier members 23A, 23B via at least one of the plurality of fasteners 27 prior to inserting the carrier members 23A, 23B into the cavity 22.

In accordance with a further aspect of the disclosure, the method can further include at step 1020 maintaining the barrier member 32 in spaced relation from the dry side 18A of the inner panel 18 via washers 80 disposed on the shanks 66 of the fasteners 27 while attaching to the barrier member 32 to the at least one carrier member 23A, 23B and then, at step 1030, bringing the barrier member 32 into abutment with the dry side 18A upon tightening the fasteners 27.

In accordance with a further aspect of the disclosure, the method can further include at step 1030 establishing a fluid-tight seal between the dry side 18A of the inner panel 18 and the barrier member 32 via a seal bead 58 on the barrier member 32 upon tightening the fasteners 27.

The foregoing description of the embodiments has been provided for purposes of illustration and description. It is not intended to be exhaustive or to limit the disclosure. Individual elements, assemblies and subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A carrier module for a motor vehicle having a door panel structure with an inner panel separating a dry side from a wet side of the door panel structure, the inner panel having at least one opening bounded by a periphery and at least one support feature, the carrier module comprising:
at least one carrier member; and
at least one alignment member extending outwardly from the at least one carrier member, the at least one alignment member being configured for engagement within the at least one support feature for maintaining the at least one carrier member in a partially assembled position unsecured to the inner panel.

2. The carrier module of claim 1, wherein the at least one carrier member has at least one fastener opening with a separate fastener secured in each said at least one fastener opening, said separate fastener being configured to extend outwardly from each said at least one fastener opening for receipt through the at least one support feature when the at least one carrier member is in the partially assembled position.

3. The carrier module of claim 2, wherein the separate fastener has a shank extending outwardly from said at least one fastener opening to an enlarged head, the shank being configured for receipt through the at least one support feature to provide the at least one alignment member with the enlarged head being configured for receipt of the dry side of the door panel structure.

4. The carrier module of claim 3, wherein the at least one support feature is at least one of a bounded slot formed through the inner panel and an open slot extending into the periphery of the at least one opening, the shank being configured for receipt through at least one of the bounded slot and the open slot.

5. The carrier module of claim 4, wherein the at least one support feature includes at least one circumferentially bounded slot formed through the inner panel and at least one open slot extending into the periphery of the at least one opening, wherein the at least one carrier member has a plurality of said at least one fastener opening with a separate fastener secured in each said plurality of fastener openings, at least one of the shanks being configured for receipt through said at least one of the bounded slot and at least one of the shanks being configured for receipt through said at least one open slot.

6. The carrier module of claim 5, wherein the at least one circumferentially bounded slot is keyhole shaped having an enlarged diameter portion and a reduced width slot portion extending from the enlarged diameter portion, at least one of the shanks being configured for receipt within the reduced width slot portion and the enlarged head being configured to overlie a substantially planar surface of the inner panel adjacent the reduced width slot portion.

7. The carrier module of claim 3, further including a barrier member configured to close off the at least one opening in the inner panel, the barrier member being attached to the at least one carrier member by said at least one fastener with the barrier member being sandwiched between the enlarged head of said at least one fastener and the at least one carrier member.

8. The carrier module of claim 7, wherein the at least one carrier member includes a pair of carrier members, the barrier member being detached from one of the pair of carrier members.

9. The carrier module of claim 8, further including a washer disposed in an interference fit on the at least one fastener between the barrier member and the at least one carrier member, the washer holding the barrier member against the enlarged head of the at least one fastener to provide a gap between the barrier member and the at least one carrier member.

10. The carrier module of claim 9, wherein the barrier member has a hinge allowing the barrier member to be folded.

11. A carrier module for a motor vehicle having a door panel structure with an inner panel and outer panel defining an internal door cavity therebetween, the inner panel having an opening bounded by a periphery sized for receipt of the carrier module therethrough with at least one of a plurality of slots extending into the periphery and a plurality of keyhole shaped openings having an enlarged diameter portion and a reduced width slot portion extending from the enlarged diameter portion, the carrier module comprising:
a pair of carrier members operably coupled to one another via at least one cable, the pair of carrier members having fastener openings; and
a plurality of fasteners having shanks threaded into the fastener openings, the shanks extending outwardly from the pair of carrier members to enlarged heads spaced from the carrier members, the shanks being configured for sliding receipt within at least one of the plurality of slots extending into the periphery and the reduced width slot portion of the plurality of keyhole shaped openings.

12. The carrier module for a motor vehicle of claim 11, wherein the shanks are configured for sliding receipt within the slots of the inner panel and the enlarged heads are configured to overlie a substantially planar surface of the inner panel adjacent the slots.

13. The carrier module of claim 11, wherein the shanks are configured for sliding receipt within the reduced width slot portion of the plurality of keyhole shaped openings and the enlarged heads are configured to overlie a substantially planar surface of the inner panel adjacent the reduced width slot portion.

14. The carrier module of claim 11, further including a barrier member attached to at least one of the carrier members by at least one of the plurality of fasteners.

15. A method of assembling a carrier module to an inner panel of a motor vehicle door, comprising:
providing a carrier module including fasteners having shanks and enlarged heads, with the shanks being threaded into fastener openings thereof;
sliding the shanks of the fasteners within at least one of a plurality of slots extending into a periphery bounding an opening in the inner panel and a reduced width slot portion of a plurality of openings extending through the inner panel; and
tightening the fasteners and bringing the enlarged heads into compression relative to the inner panel.

16. The method of claim 15, wherein the carrier module has a pair of carrier members operably coupled to one another and including fasteners having the shanks.

17. The method of claim 16, further including inserting the carrier members into an internal door cavity extending between the inner panel and an outer panel of the motor vehicle door through an opening in the inner panel.

18. The method of claim 17, further including attaching a barrier member, configured to close off the opening in the inner panel, to at least one of the carrier members via at least one of the plurality of fasteners prior to inserting the carrier members into the internal door cavity.

19. The method of claim 18, further including maintaining the barrier member in spaced relation from a dry side of the inner panel via washers disposed on the fasteners while attaching to the at least one carrier member to the inner panel and then bringing the barrier member into abutment with the dry side of the inner panel upon tightening the fasteners.

20. The method of claim 19, further including establishing a fluid-tight seal between the dry side of the inner panel and the barrier member via a seal bead on the barrier member upon tightening the fasteners.
